(19) United States
(12) Patent Application Publication
(10) Pub. No.: US 2009/0039543 A1
(43) Pub. Date: Feb. 12, 2009

(54) Polymer Composition Comprising Polyolefins And Amphiphilic Block Copolymers And Optionally Other Polymers And/Or Fillers And Method For Dying Compositions Of That Type Or Printing Thereon

(75) Inventors: Claudia Sierakowski, Seeheim-Jugenheim (DE); Ulrich Karl, Gruenstadt (DE); Mijolovic Darijo, Mannheim (DE); Karin Fischl, Ludwigshafen (DE); Michael Faber, Schifferstadt (DE); Karl Siemensmeyer, Frankenthal (DE)

Correspondence Address: CONNOLLY BOVE LODGE & HUTZ, LLP, P O BOX 2207, WILMINGTON, DE, 19899, US

(73) Assignee: BASF Aktiengesellschaft, Ludwigshafen (DE)

(21) Appl. No.: 11/915,925

(22) PCT Filed: May 19, 2006
(86) PCT No.: PCT/EP2006/062469

§ 371 Date: May 19, 2008

(30) Foreign Application Priority Data
May 30, 2005 (DE) 10 2005 025 018.1
Nov. 16, 2005 (DE) 10 2005 055 078.9
Mar. 29, 2006 (EP) 06111891.5

(51) Int. Cl. B29C 47/88; C08K 3/26; C08K 3/34; C08K 3/40; C08K 3/22; C08L 53/00

(52) U.S. Cl. 264/211.12; 525/93; 525/96; 524/427; 524/437; 524/436; 524/451; 524/442; 524/505

(57) ABSTRACT

Polymeric compositions comprising polyolefins, amphiphilic block copolymers composed of polyisobutene blocks and polyoxyalkylene blocks and also optionally other polymers and/or fillers. Processes for dyeing or for printing such compositions and the use of amphiphilic block copolymers as auxiliaries for dyeing and printing polyolefins.

The present invention relates to polymeric compositions comprising polyolefins, amphiphilic block copolymers composed of polyisobutene blocks and polyoxyalkylene blocks and also optionally other polymers and/or fillers. It further relates to a process for dyeing or printing such compositions and also to the use of amphiphilic block copolymers as auxiliaries for dyeing and printing polyolefins.

Polyolefins in general and polypropylene in particular are notable for numerous outstanding properties such as low specific density, high breaking strength, high stability to chemicals, low wettability by polar media, low water inhibition, good recyclability and also low cost. They are readily processible into various forms such as fibers, films and moldings.

Owing to the low wettability by polar substances and/or the low ability to take up polar substances, however, polyolefins and also fibers, films and moldings produced therefrom are dyeable from aqueous baths only with difficulty, if at all.

To achieve deep shades on polyolefin fibers, it has hitherto been customary to use what is known as mass coloration. In this process, the color-conferring pigment or the dye is added directly to the polypropylene melt in the extruder before the fibers are formed. This does indeed provide colorations which are both dark and fast to the rigors of actual service, but a change in color will give rise to large amounts of waste and/or require long lead times. Therefore, only the production of large batches makes economic sense. Comparatively small batches, for example for fashion-based color requirements, cannot be produced economically or in short time periods. Moreover, bright hues are difficult to achieve.

The poor post-extrusion dyeability has hitherto militated against wider use of polyolefins in the textile sector. Polypropylene fibers are rarely used despite their inherently favorable properties as apparel fibers, in particular in the sector of sports and leisure apparel.

There has therefore been no shortage of attempts to improve the post-extrusion dyeability of polyolefins.

WO 93/06177 discloses a process for dyeing fibers, in particular polyolefin fibers, wherein the fiber is treated with a composition including a disperse dye and a swelling agent and heated to a temperature just below the melting point of the fiber, so that at least a portion of the disperse dye migrates into the fiber. Residual dye composition is then removed from the surface of the fiber.

Melliand Textilberichte 77 (1996) 588-592 and 78 (1997) 604-605 disclose the dyeing of polypropylene fibers with specific disperse dyes comprising C₈- to C₁₈-alkyl radicals wherein it is preferable to additionally include surfactants in the dyeing liquor to obtain dyeings of high levelness and to increase the fixation yields. The problem with this is that dyers and finishers would have to maintain an additional stock of dyes exclusively for polyolefin dyeing, and this would be very costly.

U.S. Pat. No. 6,679,754 discloses the use of polyetheresteramides in polyolefins to improve their dyeability.

WO 04/35635 discloses the use of polyisobutene modified with terminal, polar groups for improving the dyeability of polyolefins. Dyes mentioned include for example anionic, cationic, mordant, direct, disperse or vat dyes. One example utilizes a polyisobutene succinic anhydride (Mₙ 550 g/mol) having a terminal group from a polyglycol ether (Mₙ 300 g/mol) as an auxiliary for dyeing polypropylene with a cationic dye. However, the dyeings are not always intensive enough, especially produced with disperse dyes or metal complex dyes. When dyeing with particulate vat dyes, it is difficult to obtain through-dyed and not just surficially dyed fibers.

WO 04/72024 discloses the use of polyisobutenephosphonic acids for improving the dyeability of polypropylene.

However, neither reference discloses the use of amphiphilic block copolymers composed of polyisobutene blocks and also polyoxyalkylene blocks as an auxiliary for dyeing polyolefins.

WO 95/10648, EP-A 1 138 810 and WO 02/92891 disclose the use of various diesters of polyalkylene glycols with fatty acids having up to 21 carbon atoms for hydrophilicizing polypropylene. Preference is given to using polyethylene glycols having a molecular weight in the range from 300 to 600 g/mol. Dyeing of the modified polypropylenes is not disclosed.

Our prior application DE-A 102004007501 discloses aqueous polymeric dispersions stabilized by di-, tri- or multiblock copolymers composed of polyisobutene units and also polyoxyalkylene units. The use of these polymers for improving the dyeability of polyolefins is not disclosed.

It is an object of the present invention to provide polyolefins with improved dyeability or printability and an improved process for post-extrusion dyeing of polyolefins, in particular polypropylene, with aqueous dyebaths. The dyeings obtained should be in particular homogeneous and free of stripiness.

We have found that this object is achieved by polymeric compositions which each comprise at least one polyolefin and also at least one block copolymer comprising
at least one hydrophobic block (A) constructed essentially of isobutene units, and
at least one hydrophilic block (B) constructed essentially of oxyalkylene units and having an average molar mass Mₙ of not less than 1000 gμmol.

The polymeric compositions may be undyed or else dyed compositions which further comprise at least one dye. The polymeric compositions may optionally further comprise further polymers and/or fillers.

A second aspect of the present invention is a process for dyeing a polymer comprising treating the specified undyed polymeric composition with a formulation comprising at least water and a dye, wherein the polymeric composition is heated during and/or after the treatment to a temperature greater than its glass transition temperature T_{g} but lower than its melting temperature.

A third aspect of the present invention is a process for printing a substrate comprising printing an unprinted substrate composed of a polymeric composition with a suitable printing paste at least comprising a rheological auxiliary, a solvent and also a dye wherein the polymeric composition is heated during and/or after the printing to a temperature greater than its glass transition temperature T_{g} but lower than its melting temperature.

A fourth aspect of the present invention is the use of the specified block copolymers as an auxiliary for dyeing or printing polyolefins or polymer blends containing polyolefins. We found that, surprisingly, the polymeric compositions of the present invention have a series of advantages.

The process of the present invention provides uniformly dyed compositions having higher rub fastnesses and very good wash fastnesses. Bright hues are thus obtainable in a simpler manner.

Furthermore, the mechanical properties of polyolefins are positively influenced through the present invention's addition of block copolymers. The compositions are very useful for filling with inorganic or organic fillers. The present invention's use of block copolymers instead of conventional auxiliaries distinctly improves the impact toughness and breaking extension of filled polyolefins.

Moreover, improved processing properties are also obtainable. Significantly higher texturing speeds can be achieved with fibers composed of the polymeric compositions of the present invention than in the case of polyolefins without added block copolymers, not only for solution-dyed fibers but also for fibers without color pigments.

The present invention will now be discussed in detail.

The polymeric composition of the present invention comprises at least one polyolefin and also at least one block copolymer composed of at least one hydrophobic block (A) and also at least one hydrophilic block (B).

The block copolymer serves as an auxiliary to improve the properties, for example the dyeability of the polyolefin. When mixtures of various polyolefins are used, it also acts as an efficient compatibilizer. The blocks (A) and (B) are linked by means of suitable linking groups. They may each be linear or else have branches.

Block copolymers of this kind are known and can be prepared on the basis of methods and starting compounds known in principle to one skilled in the art.

The hydrophobic blocks (A) are constructed essentially of isobutene units. They are obtainable by polymerizing isobutene. The blocks may also, however, include other comonomers as constituent units, to a minor extent. Constituent units of this kind may be used to fine-tune the properties of the block. Comonomers for mention, besides 1-butene and cis- or trans-2-butene, include, in particular, isoolefins having 5 to 10 carbon atoms such as 2-methyl-1-butene, 2-methyl-1-pentene, 2-methyl-1-hexene, 2-ethyl-1-pentene, 2-ethyl-1-hexene and 2-propyl-1-heptene, or vinylaromatics such as styrene and α-methylstyrene, C₁-C₄-alkylstyrenes such as 2-, 3- and 4-methylstyrene and 4-tert-butylstyrene. The fraction of such comonomers should, however, not be too great. As a general rule the amount thereof should not exceed 20% by weight of the amount of all constituent units of the block. Besides the isobutene units and/or comonomers, the blocks may also comprise the initiator molecules or starter molecules used at the start of the polymerization, or fragments thereof. The polyisobutenes thus prepared may be linear, branched or star-shaped. They may have functional groups only at one chain end or else at two or more chain ends.

Starting materials for the hydrophobic blocks A are functionalized polyisobutenes. Functionalized polyisobutenes can be prepared starting from reactive polyisobutenes by providing the latter with functional groups in single-stage or multistage reactions that are known in principle to the skilled worker. Reactive polyisobutene is understood by the skilled worker to refer to polyisobutene having a very high fraction of terminal α-olefin groups. The preparation of reactive polyisobutenes is likewise known and described in detail, for example, in the above-cited documents WO 04/9654, pages 4 to 8, and WO 04/35635, pages 6 to 10.

Preferred embodiments of the functionalization of reactive polyisobutene comprise:
i) reaction with aromatic hydroxy compounds in the presence of an alkylation catalyst to give aromatic hydroxy compounds alkylated with polyisobutenes,
ii) reaction of the polyisobutene block with a peroxy compound to give an epoxidized polyisobutene,
iii) reaction of the polyisobutene block with an alkene that has a double bond substituted by electron-attracting groups (enophile), in an ene reaction,
iv) reaction of the polyisobutene block with carbon monoxide and hydrogen in the presence of a hydroformylation catalyst to give a hydroformylated polyisobutene,
v) reaction of the polyisobutene block with a phosphorus halide or a phosphorus oxychloride to give a polyisobutene functionalized with phosphono groups,
vi) reaction of the polyisobutene block with a borane and subsequent oxidative cleavage to give a hydroxylated polyisobutene,
vii) reaction of the polyisobutene block with an SO₃ source, preferably acetyl sulfate or oleum, to give a polyisobutene having terminal sulfo groups,
viii) reaction of the polyisobutene block with oxides of nitrogen and subsequent hydrogenation to give a polyisobutene having terminal amino groups.

With regard to all details for implementing the specified reactions we refer to the remarks in WO 04/35635, pages 11 to 27.

Particular preference is given to embodiment iii). With very particular preference maleic anhydride is used as enophile for this reaction. In that case the resulting polyisobutenes are functionaiized with succinic anhydride groups (polyisobutenylsuccinic anhydride, PIBSA).

The molar mass of the hydrophobic blocks A is decided by the skilled worker in accordance with the desired application. In general the hydrophobic blocks (A) each have an average molar mass Mₙ of 200 to 10 000 g/mol. Mₙ is preferably 300 to 8000 g/mol, more preferably 400 to 6000 g/mol, and very preferably 500 to 5000 g/mol.

The hydrophilic blocks (B) are composed substantially of oxyalkylene units. Oxyalkylene units are, in a way known in principle, units of the general formula —R¹—O—. R¹ here is a divalent aliphatic hydrocarbon radical which may also, optionally, have further substituents. Additional substituents on the radical R¹ may be, in particular, O-containing groups, examples being >C═O groups or OH groups. One hydrophilic block may also, of course, comprise two or more different oxyalkylene units.

The oxyalkylene units can be, in particular, —(CH₂)₂—O—, —(CH₂)₃—O—, —(CH₂)₄—O—, —CH₂—CH(R²)—O, —CH₂—CHOR³—CH₂O—, where R² is an alkyl group, especially C₁-C₂₄-alkyl, or an aryl group, especially phenyl, and R³ is a group selected from the group consisting of hydrogen, C₁-C₂₄alkyl, R¹—C(═O)— and R¹—NH—C(═O)—.

The hydrophilic blocks may also comprise further structural units, such as ester groups, carbonate groups or amino groups, for example. They may additionally comprise the initiator or starter molecules used at the start of the polymerization, or fragments thereof. Examples comprise terminal groups R²—O—, where R² is as defined above.

As a general rule the hydrophilic blocks comprise as their principal components ethylene oxide units —(CH₂)₂—O— and/or propylene oxide units —CH₂—CH(CH₃)—O, while higher alkylene oxide units, i.e., those having more than 3 carbon atoms, are present only in small amounts for the purpose of fine-tuning the properties. The blocks may comprise random copolymers, gradient copolymers, alternating copolymers or block copolymers of ethylene oxide and propylene oxide units. The amount of higher alkylene oxide units should not exceed 10%, preferably 5%, by weight. Preferred blocks are those comprising at least 50% by weight of ethylene oxide units, preferably 75% and more preferably at least 90% by weight of ethylene oxide units. With very particular preference they are pure polyoxyethylene blocks.

The hydrophilic blocks B are obtainable in a way which is known in principle: for example, by polymerizing alkylene oxides and/or cyclic ethers having at least 3 carbon atoms, and also, optionally, further components. They may also be prepared by polycondensation of dialcohols and/or polyalcohols, suitable starters, and, optionally, further monomeric components.

Examples of suitable alkylene oxides as monomers for the hydrophilic blocks B comprise ethylene oxide and propylene oxide and additionally 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, 2,3-hexene oxide, 3,4-hexene oxide, 2-methyl-1,2-pentene oxide, 2-ethyl-1,2-butene oxide, 3-methyl-1,2-pentene oxide, decene oxide, 4-methyl-1,2-pentene oxide, styrene oxide, or are formed from a mixture of oxides from raffinate streams available industrially. Examples of cyclic ethers comprise tetrahydrofuran. It is of course also possible to use mixtures of different alkylene oxides. The skilled worker will make an appropriate selection from the monomers and/or further components in accordance with the desired properties of the block.

The hydrophilic blocks B may also be branched or star-shaped. Blocks of this kind are obtainable by using starter molecules having at least 3 arms. Examples of suitable starters comprise glycerol, trimethylolpropane, pentaerythritol or ethylenediamine.

The synthesis of alkylene oxide units is known to the skilled worker. Details are set out at length in, for example, “Polyoxyalkylenes” in Ullmann's Encyclopedia of Industrial Chemistry, 6th edition, Electronic Release.

The molar mass of the hydrophilic blocks B is at least 1000 g/mol and is decided by the skilled worker in accordance with the desired application. At less than 1000 g/mol the dyeing results are often unsatisfactory.

In general the hydrophilic blocks (B) each have an average molar mass Mₙ of 1000 to 20 000 g/mol. Mₙ is preferably 1250 to 18 000 g/mol, more preferably 1500 to 15 000 g/mol, and very preferably 2500 to 8000 g/mol.

The synthesis of the block copolymers used in the present invention can preferably be performed by first preparing the hydrophilic blocks B separately and reacting them with the functionalized polyisobutenes in a polymer-analogous reaction to form block copolymers.

The constituent units for the hydrophilic and hydrophobic blocks in this case have complementary functional groups, i.e., groups which are able to react with one another with the formation of linking groups.

The functional groups of the hydrophilic blocks are, naturally, preferably OH groups, although they may also, for example, be primary or secondary amino groups. OH groups are particularly suitable as complementary groups for reaction with PIBSA.

In a further embodiment of the invention the synthesis of the blocks B may also be performed by reacting polyisobutenes having polar functional groups (i.e. blocks A) directly with alkylene oxides, with the formation of blocks B.

The structure of the block copolymers used in the present invention may be influenced by selecting type and amount of the starting materials for the blocks A and B and also the reaction conditions, in particular the sequence of addition.

The blocks A and/or B may be arranged terminally, i.e., joined only to one other block, or else they may be joined to two or more other blocks. The blocks A and B may be linked to one another, for example, linearly in alternating arrangement with one another. In principle any number of blocks may be used. As a general rule, however, there are not more than 8 blocks each of A and B respectively This results, at its most simple, in a diblock copolymer of the general formula AB. The copolymers in question may additionally be triblock copolymers of the general formula ABA or BAB. It is of course also possible for two or more blocks to follow one another: for example, ABAB, BABA, ABABA, BABAB or ABABAB.

The copolymers in question may additionally be star-shaped and/or branched block copolymers or else comb block copolymers, in which more than two blocks A are attached to one block B or more than two blocks B are attached to one block A in each case. They may, for example, be block copolymers of the general formula ABₘ or BAₘ, m being a natural number ≧3, preferably 3 to 6 and more preferably 3 or 4. In the arms or branches it is of course also possible for two or more blocks A and B to follow one another: for example, A(BA)ₘ or B(AB)ₘ.

The synthesis possibilities are depicted below exemplarily for OH groups and succinic anhydride groups (labeled S), without any intention thereby that the invention should be restricted to the use of functional groups of these kinds.

HO—[B]-OH hydrophilic blocks having two OH groups
[B]-OH hydrophilic blocks having only one OH group
F[B]-(OH)ₓ hydrophilic blocks having x OH groups (x≧3)
[A]-S polyisobutene having one terminal group S
S—[A]-S polyisobutene having two terminal groups S
[A]-S_{y} polyisobutene having y groups S (y≧3)

The OH groups may be linked in a way which is known in principle with the succinic anhydride groups S, with the formation of ester groups with one another. The reaction may be performed, for example, with heating and without solvent. Suitable reaction temperatures are, for example, from 80 to 150° C.

Triblock copolymers A-B-A are produced, for example, in a simple way by reacting one equivalent of HO—[B]-OH with two equivalents of [A]-S. This is depicted below by way of example with complete formulae. The example used is the reaction of PIBSA and a polyethylene glycol:

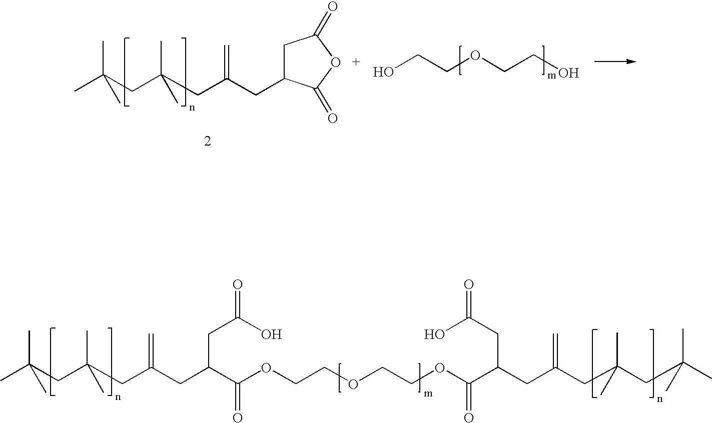

Here, n and m are, independently of one another, natural numbers. They are chosen by the skilled worker such as to give the molar masses defined at the outset for the hydrophilic blocks and the hydrophobic blocks, respectively.

Star-shaped or branched block copolymers BAₓ can be obtained by reacting [B]-(OH)ₓ with x equivalents of [A]-S.

For the skilled worker in the field of polyisobutenes it is clear that the block copolymers obtained may also still have residues of starting materials, depending on the preparation conditions. Moreover, they may be mixtures of different products. Triblock copolymers of formula ABA may still comprise, for example, diblock copolymers AB and also functionalized and unfunctionalized polyisobutene. With advantage these products can be used without further purification for the application. It is, however, also possible, of course, for the products to be purified as well. Purification methods are known to the skilled worker.

Preferred block copolymers for embodying this invention are triblock copolymers of the general formula ABA and their mixture with diblock copolymers AB and also, if appropriate, by-products.

The amphiphilic block copolymers described are used as auxiliaries for improving the properties of polyolefins in the present invention, for example for improving the dyeing of polyolefins or for improving rheological properties.

Useful polyolefins include in principle all known polyolefins. They may be for example homopolymers or copolymers comprising ethylene, propylene, 1-butene, 2-butene, isobutene, 1-pentene, 1-hexene, 1-heptene, 1-octene, styrene or α-methylstyrene as monomers. Preferably they are polyolefins comprising C₂- to C₄-olefins as main constituent, more preferably homo- or copolymers of polypropylene or of polyethylene. Copolymers may be random copolymers or block copolymers. Suitable comonomers in copolymers are preferably—depending on polyolefin foundation species—ethylene or other α-olefins, dienes such as 1,4-hexadiene, 1,5-hexadiene, 1,6-heptadiene, 2-methylpenta-1,4-diene, 1,7-octadiene, 6-methylhepta-1,5-diene, or polyenes such as octatriene and dicyclopentadiene. The fraction of the copolymer that is attributable to the comonomers is generally not more than 40% by weight and preferably not more than 30% by weight, based on the sum total of all the constituents of a monomer, for example from 20% to 30% by weight or 2% to 10% by weight depending on the application.

In one preferred embodiment of the present invention the polyolefin is polyethylene, for example LDPE, HDPE or LLDPE.

In one particularly preferred embodiment the polyolefin is polypropylene. The polypropylene may be a homopolymer or a copolymer. Useful comonomers include in particular ethylene and also the abovementioned α-olefins, dienes and/or polyenes. The choice of polypropylene is not restricted. Viscid polypropylenes having a high melt flow index are particularly advantageous to process. For example, the polypropylene may have an MFR melt flow index (230° C., 2.16 kg) of less than 40 g/10 min.

The polyolefins in question may also be blends of various polyolefins for example of polypropylene and polyethylene.

As well as polyolefins and block copolymers, the compositions of the present invention may comprise chemically different polymers other than polyolefins. For example, further polymers may be polyamides or polyesters, in particular PET. Such additions make it possible to fine tune the properties of the polymeric compositions.

The amount of further polymers optionally present is determined by the skilled person in accordance with the properties desired for the polymeric composition. However, the amount of further polymers optionally present should generally not exceed 20% by weight, based on the total amount of polyolefins and also of the further polymers, i.e., the amount of all polymers other than the amphiphilic block copolymers. If present, amounts from 0.1% to 20% by weight will be found advantageous, preferably from 1% to 15% by weight, more preferably from 2% to 10% by weight and most preferably from 3% to 7% by weight.

The polyesters used may be customary PET having a melting point in the range from 255 to 265° C. Modified PET having additional soft segments and accordingly a lower crystallinity or melting point may be used with particular advantage. Polyesters having a melting point in the range from 50 to 250° C. and preferably in the range from 60 to 200° C. may be used with particular advantage for embodying the invention. The use of such polyester additives leads to particularly readily dyeable fibers having particularly good lightfastness and a very advantageous liquor exhaustion. Furthermore, admixtures of such polyesters render the fibers dyeable at 100° C.

Polyesters of this kind are obtainable by synthesizing them by replacing some of the terephthalic acid units in the polyester with aliphatic dicarboxylic acid units, in particular with adipic acid units. For example, a mixture of terephthalic acid and adipic acid in a molar ratio of 4:1 to 1:20 can be used. In addition to or in lieu of this substitution, the ethylene glycol units can be replaced by longer-chain diols, in particular C₃- to C₆-alkanediols, for example 1,4-butanediol or 1,6-hexanediol.

The amphiphilic block copolymers used according to the present invention not only benefit dyeability, but also act as efficient compatibilizers for blending various polymers. Reference may be made here in particular to blends of various polyolefins, such as for example polypropylene and polyethylene or polypropylene with polyester or potyamide.

The polymeric compositions of the present invention may optionally comprise yet further typical additives and auxiliaries. Examples comprise antistats, stabilizers or fillers. Such additives are known to one skilled in the art. Details are discussed for example in “Polyolefine” in Ullmann's Encyclopedia of Technical Chemistry, 6th Edition, 2000, Electronic Release.

Fillers for filling polyolefins are known in principle to the skilled person. Fillers for filling polyolefins are finely divided inorganic and/or organic solids with which the properties of the polyolefins, for example hardness, extensibility, density, impact toughness, gas permeability or electrical conductivity, can be influenced. Furthermore, fillers can also be used as flame retardants. Fillers for filling polyolefins may be not only more or less spherical fillers but also platelets and/or acicular or fibrous fillers. Examples of suitable fillers comprise carbonates, hydroxides, oxides, mixed oxides, silicates or sulfates.

CaCO₃ is an example of a possible filler. CaCO₃ may be of natural origin, as for example in the case of ground limestone, ground marble or ground chalk. But it may also be precipitated CaCO₃ of industrial origin. Further examples comprise dolomite CaMg(CO₃)₂, natural or industrial SiO₂ such as, for example, quartz, pyrogenic SiO₂ or precipitated silica, BaSO₄, CaSO₄, ZnO, TiO₂, MgO, Al₂O₃, graphite, carbon black, sheet silicates such as, for example, kaolin, montmorillonite, mica or talc. Fibers such as, for example, glass fibers, carbon fibers or aramid fibers may also be used. Examples of fillers useful as flame retardants comprise Al(OH)₃ or Mg(OH)₂. The fillers may also of course be modified in a manner known in principle, for example by coating with suitable dispersants and/or hydrophobicizers.

The typical size of suitable fillers is generally in the range from 0.5 to 5 μm and preferably in the range from 1 to 3 μm. In the case of spherical or substantially spherical particles, this specification relates to the diameter, otherwise to the length of the particles.

However, it is also possible to use nanoparticles having a size in the range from 1 to 500 nm. Suitable nanoparticles comprise for example nanoparticulate SiO₂ or ZnO. It is further possible to use nanoparticulate sheet silicates, especially organically modified sheet silicates, for example montmorillonite, hectorite, saponite, beidelite or bentonite. The production of such nanoparticles is described in WO 2004/111122 and corresponding products are commercially available. Such nanoparticles can have a layer thickness of only about 1 nm, whereas their length and width can be in the range from 100 nm to 500 nm.

The invention is preferably carried out using CaCO₃, talc, glass fibers and also sheet silicates, in particular nanoparticulate sheet silicates. It may furthermore be preferable to use flame retardants, more preferably Al(OH)₃ and/or Mg(OH)₂.

The amount of any fillers used is determined by the skilled person according to the filler used and also according to the properties desired for the polymer. The amount of any filler used is generally in the range from 1% to 100% by weight based on the sum total of all the components of the composition.

Fillers for improving mechanical properties may advantageously be added in an amount of 5% to 50% by weight, preferably 10% to 40% by weight and more preferably 15% to 35% by weight.

Fillers useful as flame retardants such as Al(OH)₃ or Mg(OH)₂ for example may advantageously be used in amounts of 25% to 100% by weight and more preferably 35% to 80% by weight and more preferably 40% to 60% by weight.

Owing to their high specific surface area, it is advisable to use nanoparticles in amounts of not more than 10% by weight, for example in the range from 0.1% to 10% by weight and preferably in the range from 0.2% to 5% by weight.

The advantages of the present invention's use of amphiphilic block polymers become very particularly apparent in the case of filled polyolefins. Filling polyolefins frequently reduces their breaking extension. When amphiphilic block copolymers are used, the decrease in breaking extension on filling is distinctly reduced. In other words, polymeric compositions have superior mechanical technological properties for the same fill level, or alternatively the polymer can be filled with a larger amount of an inexpensive filler.

The polymeric compositions of the present invention may be present in any desired form, for example as any kinds of moldings or films. But preferably the polymeric composition is present in the form of fibers, yarns, wovens, nonwovens, formed-loop knits, drawn-loop knits and/or other textile materials. Processes for producing fibers or derived yarns, wovens, nonwovens and/or other textile materials from polymers or polymeric compositions are known to one skilled in the art. The materials may be for example apparel textiles, examples being sportswear, underwear, including functional underwear, outerwear, jackets or the like, or else home textiles, examples being curtains, tablecloths, bedding, upholstery fabrics, carpets or the like. They may also be industrial textiles, examples being carpets or nonwovens for automotive applications.

The polymeric compositions of the present invention may be produced by various techniques. For example, the polyolefins may be produced in the presence of the block copolymers used according to the present invention. It is further possible first to produce polyolefin moldings, in particular fibers, yarns, wovens and/or nonwovens, and to treat them subsequently on the surface with the block copolymers used according to the present invention, if appropriate followed by an annealing step.

In the preferred embodiment of the present invention, the block copolymers are intensively mixed with the polyolefins and also optionally further components, in particular any other polymers and/or fillers present, by heating until molten by means of suitable apparatuses. Kneaders, single-screw extruders, twin-screw extruders or other dispersing assemblies can be used by way of example. The discharge of the molten polymeric composition from the mixing assemblies may be effected in a basically known manner via dies. For example, strands can be extruded and chopped into pellets. But the molten mass may alternatively be molded directly to form desired shaped articles, for example by injection molding or blow molding, or it may be extruded through suitable dies to form fibers.

The block copolymer, or the mixture of various block copolymers, may preferably be added to the polyolefins inclusive of any further components present, without solvent, but may also be added in solution.

The temperature for the mixing/blending is selected by one skilled in the art and depends on the identity of the polyolefins used and if appropriate of further polymers. The polyolefins should on the one hand soften to a sufficient extent that commixing is possible. On the other hand, they should not become too runny, since it is otherwise impossible to introduce sufficient shearing energy and, moreover, thermal degradation is possibly a risk. As a general rule it is possible to employ temperatures from 120 to 300° C. without any intention that the invention shall be restricted thereto. It proves particularly advantageous in this context that the block copolymers used according to the present invention possess high thermal stability.

The polyolefin content of the polymeric compositions according to the present invention is generally in the range from 35% to 99.95% by weight, preferably in the range from 50% to 99.9% by weight and more preferably in the range from 60% to 99.85% by weight and most preferably in the range from 70% to 99.8% by weight, all based on the sum total of the all the components of the composition.

If no fillers are present, the amounts of polyolefins can also be higher. In this case, the compositions generally comprise from 75% to 99.5% by weight of the polyolefins, preferably from 85% to 99.9% by weight, more preferably from 90% to 99.85% by weight and most preferably from 95% to 99.8% by weight, all based on the sum total of all the components of the composition.

The amount of block copolymer is determined by one skilled in the art according to the properties desired for the composition. The amount of block copolymer is generally in the range from 0.05% to 10% by weight, based on the sum total of all the components of the composition, preferably in the range from 0.1% to 6% by weight, more preferably in the range from 0.3% to 5% by weight and most preferably in the range from 0.5% to 3.0% by weight.

In one preferred embodiment of the process the block copolymers can also be incorporated in a two-stage process. To this end, at least one block copolymer is mixed with only a portion of the polyolefins and other polymers, if appropriate, by heating. The previously described techniques for mixing can be used. Such a concentrate may comprise 5% to 50% by weight and preferably 20% to 40% by weight of the block copolymer. The concentrate is then mixed in a second step with the rest of the polyolefins by heating and formed according to the intended use. For example, filaments may be produced which may be further processed into yarns, wovens, nonwovens or other textile materials.

The still undyed polymeric compositions produced as described, in particular in the form of fibers, yarns, wovens, nonwovens and/or other textile materials, are simple to dye by the process of the present invention. The present invention's use of the block copolymers distinctly enhances the affinity of the polyolefins for dyes, in particular for disperse dyes. Dyed fabrics, materials or the like are obtained in this way. More particularly, dyed apparel or home textiles are obtainable in this way. The entire fabric may be dyed. But it is also possible to initially dye the fibers only and then to process the dyed fibers into textile materials.

The process of the present invention comprises treating the undyed polymeric composition with a formulation comprising at least water and a dye. An aqueous formulation for dyeing textile materials is also known as a liquor by those skilled in the art.

The formulation preferably comprises water only. But it is also possible for small amounts of water-miscible organic solvents to be present as well. Examples of such organic solvents comprise monohydric or polyhydric alcohols, examples being methanol, ethanol, n-propanol, i-propanol, ethylene glycol, propylene glycol or glycerol. Ether alcohols are another possibility. Examples comprise monoalkyl ethers of (poly)ethylene or (poly)propylene glycols such as ethylene glycol monobutyl ether. The amount of such solvents other than water, however, should not exceed, in general, 20% by weight, preferably 10% by weight and more preferably 5% by weight based on the sum total of all the solvents of the formulation or liquor.

The formulation may in principle utilize all known dyes, examples being cationic dyes, anionic dyes, mordant dyes, direct dyes, disperse dyes, ingrain dyes, vat dyes, metalized dyes, reactive dyes, sulfur dyes, acid dyes or substantive dyes.

The present invention preferably utilizes a disperse dye, a mixture of various disperse dyes or an acid dye or a mixture of various acid dyes.

A person skilled in the art knows what is meant by “disperse dye”. Disperse dyes are dyes with a low solubility in water which are used in disperse, colloidal form for dyeing, in particular for dyeing fibers and textile materials.

The invention may in principle utilize any desired disperse dye. The disperse dyes utilized may have various chromophores or mixtures thereof. More particularly, they may be azo dyes or anthraquinone dyes, They may further be quinophthalone, naphthalimide, naphthoquinone or nitro dyes. Examples of disperse dyes comprise C.I. Disperse Yellow 3, C.I. Disperse Yellow 5, C.I. Disperse Yellow 64, C.I. Disperse Yellow 160, C.I. Disperse Yellow 211, C.I. Disperse Yellow 241, C.I. Disperse Orange 29, C.I. Disperse Orange 44, C.I. Disperse Orange 56, C.I. Disperse Red 60, C.I. Disperse Red 72, C.I. Disperse Red 82, C.I. Disperse Red 388, C.I. Disperse Blue 79, C.I. Disperse Blue 165, C.I. Disperse Blue 366, C.I. Disperse Blue 148, C.I. Disperse Violet 28 or C.I. Disperse Green 9. A person skilled in the art knows all about the nomenclature of dyes. The complete chemical formulae may be looked up in pertinent textbooks and/or databases (for example “Colour Index”). Further details concerning disperse dyes and further examples are also discussed at length for example in “Industrial Dyes”, Edt. Klaus Hunger, Wiley-VCH, Weinheim 2003, pages 134 to 158.

It will be appreciated that mixtures of various disperse dyes can be used as well. Combination shades are obtainable in this way. Preference is given to such disperse dyes as possess good fastnesses and permit trichromatic dyeing.

One skilled in the art is familiar with the term “acid dye”. Acid dyes comprise one or more acid groups, for example a sulfonic acid group, or a salt thereof. These may comprise various chromophores or mixtures of chromophores. More particularly, they may be azo dyes. Examples of acid dyes comprise monoazo dyes such as C.I. Acid Yellow 17, C.I. Acid Blue 92, C.I. Acid Red 88, C.I. Acid Red 14 or C.I. Acid Orange 67, disazo dyes such as C.I. Acid Yellow 42, C.I. Acid Blue 113 or C.I. Acid Black 1, trisazo dyes such as C.I. Acid Black 210, C.I. Acid Black 234, metalized dyes such as C.I. Acid Yellow 99, C.I. Acid Yellow 151 or C.I. Acid Blue 193, mordant dyes such as C.I. Mordant Blue 13 or C.I. Mordant Red 19 or acid dyes having various other structures such as C.I. Acid Orange 3, C.I. Acid Blue 25 or C.I. Acid Brown 349. Further details concerning acid dyes and further examples are also discussed at length for example in “Industrial Dyes”, Edt. Klaus Hunger, Wiley-VCH, Weinheim 2003, pages 276 to 295. It will be appreciated that mixtures of various acid dyes can be used as well.

The amount of dye in the formulation will be decided upon by one skilled in the art according to the intended application.

The formulation, as well as solvents and dyes, may comprise further, auxiliary components. Examples comprise typical textile auxiliaries such as dispersing and leveling agents, acids, bases, buffer systems, surfactants, complexing agents, defoamers or stabilizers against UV degradation, A UV absorber may preferably be used as auxiliary.

The dyeing is preferably done with a neutral or acidic formulation, for example with a pH from 3 to 7, preferably 4 to 6.

The treating with the polymeric composition, in particular the fibers, yarns, wovens, nonwovens and/or other textile materials with the aqueous dye formulation may be effected by means of customary dyeing processes, for example by dipping into the formulation, by spraying with the formulation or by coating the formulation by means of suitable apparatuses. Processes may be continuous or batch operations. Dyeing apparatuses will be known to one skilled in the art. Dyeing may be done for example batchwise using reel becks, yarn-dyeing apparatuses, beam-dyeing apparatuses or jets or continuously by slop padding, face padding, spraying or foam coating processes using suitable drying and/or fixing means.

The ratio of polymeric composition, in particular of the fibers, yarns, wovens, nonwovens and/or other textile materials to the dye formulation (also known as “liquor ratio”) and also in particular the dye itself is decided by one skilled in the art according to the intended application. The general case is a polymeric composition/dye formulation ratio in the range from 1:5 to 1:50 and preferably in the range from 1:10 to 1:50 and also a dye quantity in the formulation of about 0.5% to 5% by weight and preferably 1% to 4% by weight based on the polymeric composition without any intention that the invention shall be restricted to this range.

According to the invention, the polymeric composition is heated during and/or after the treatment to a temperature greater than its glass transition temperature T_{g} but less than its melting temperature. This may be preferably done by heating the entire formulation to the temperature in question and dipping the polymeric composition into the formulation.

However, it is also possible for the polymeric composition to be treated with the formulation at a temperature below T₉, if appropriate dried and subsequently for the treated polymeric composition to be heated to a temperature above T_{g}. It will be appreciated that combinations of the two possibilities are possible as well.

The temperature during the treatment does of course depend on the identity of the particular polyolefin and of the dye used. The glass transition temperatures and also melting temperatures of polyolefins and also other polymers will be known to one skilled in the art or are easily determined in a known manner. The treatment temperature is in general not less than 60° C., in particular in the range from 60 to 140° C. and preferably in the range from 80 to 140° C. Particularly temperatures from 95 to 140° C. have proved useful for polypropylene homo and copolymers.

In the course of the thermal treatment the dye passes into the polymeric composition to form a dyed polymeric composition. In the dyed polymeric composition the distribution of the dye is preferably more or less uniform, although the composition may also have concentration gradients. The dye is preferably a disperse or acid dye and most preferably a disperse dye.

The duration of the treatment is determined by one skilled in the art according to the identity of the polymeric composition, of the formulation and also of the dyeing conditions. It is also possible to alter the temperature as a function of the treatment time. For example, a comparatively low initial temperature in the range from 70 to 100° C. for example may be gradually raised to a temperature in the range from 120 to 140° C. Proven utility is a heating-up phase of 10 to 90 min and preferably 20 to 60 min and a subsequent high-temperature phase of 10 to 90 min and preferably 20 to 60 min min. Alternatively, a short treatment having a duration of about 0.5 to 5 min for example is possible with steam or with superheated steam.

Dyeing may be followed by a conventional aftertreatment, for example with laundry detergents or oxidatively or reductively acting afterclearing agents or fastness improvers. Such aftertreatments are known in principle to one skilled in the art.

The dyed or undyed polymeric compositions of the present invention are printable to outstanding effect. Substrates composed of the polymeric compositions of the present invention are used for printing. The substrates may be any desired substrates, examples being self-supporting films composed of the polymeric compositions of the present invention. Textile substrates are preferred. Examples of textile substrates comprise wovens, formed-loop knits or nonwovens composed of the polymeric compositions of the present invention.

Processes for printing textile substrates will be known in principle to one skilled in the art. Screen printing may be preferable. Textile-printing pastes may be utilized in a basically known manner that generally comprise at least one binder, at least one dye and at least one thickener and also optionally further additives such as for example wetting agents, rheological auxiliaries or UV stabilizers. The aforementioned dyes may be used as colorants. Disperse or acid dyes are preferred, disperse dyes being particularly preferred. Textile-printing pastes and also their customary constituents will be known to one skilled in the art.

The printing process of the present invention may be carried out as a direct printing process; that is, the printing paste is transferred directly to the substrate. It will be appreciated that one skilled in the art may also effect printing by means of other processes, an example being direct printing using ink jet technology.

According to the present invention, a thermal aftertreatment is carried out in the case of printing as well. To this end, the substrate composed of the polymeric composition of the present invention is heated during and/or preferably after printing to a temperature greater than its glass transition temperature T_{g} but lower than its melting temperature.

The printed substrate may preferably be dried first, for example at 50 to 90° C. for a period in the range from 30 seconds to 3 minutes. The thermal treatment is carried out subsequently, preferably at the temperatures already mentioned. The period of time which would be found suitable is that from 30 seconds to 5 minutes in conventional apparatus, examples being atmospheric drying cabinets, tenters or vacuum drying cabinets.

Dyeing or printing may be followed by a customary aftertreatment as already described above.

The dyeing and/or printing process of the present invention provides colored polymeric compositions which, as well as the components already described, further comprise dyes, in particular disperse dyes or acid dyes and more preferably disperse dyes. The amount of dye is preferably in the range from 0.5% to 4% by weight based on the amount of all the components of the composition. The dyed polymeric compositions may be apparel or else home textiles for example.

The polymeric compositions dyed and/or printed according to the present invention exhibit more intensive and more uniform colorations than prior art materials. They further possess better rub fastnesses and very good wash fastnesses.

The examples which follow illustrate the invention.

### A) Preparation of Block Copolymers Used as Dyeing Auxiliaries

### Block Copolymer 1:

Preparation of a block copolymer of ABA structure from PIBSA 550 and polyethylene glycol 1500

Reaction of PIBSA₅₅₀ (molar mass Mₙ 550, hydrolysis number HN=162 mg/g KOH) with Pluriol® E1500 (polyethylene oxide, Mₙ≈1500)

In a 4 l three-neck flask with internal thermometer, reflux condenser and nitrogen tap, 693 g of PIBSA (Mₙ=684; dispersity index DP=1.7) and 750 g of Pluriol® E1500 (Mₙ≈1500, DP=1.1) were introduced. In the course of heating to 80° C., the flask was evacuated 3× and blanketed with N₂. The reaction mixture was then heated to 130° C. and held at this temperature for 3 h. Thereafter the product was cooled to room temperature. The following spectra were recorded:

IR spectrum (KBr) in cm⁻¹:

OH stretching vibration at 3308; C—H stretching vibration at 2953, 2893, 2746; 0═O stretching vibration at 1735; C═C stretching vibration at 1639; further vibrations of the PIB skeleton: 1471, 1390, 1366, 1233; ether vibration of the Pluriol at 1111.

1-H-NMR spectrum (CDCl₃, 500 MHz, TMS, room temperature) in ppm: 4.9-4.7 (C═C of PIBSA); 4.3-4.1 (C(O)—O—CH₂CH₂—); 3.8-3.5 (O—CH₂—CH₂—O, PEO chain); 3.4 (O—CH₃); 3.1-2.9; 2.8-2.4; 2.3-2.1; 2.1-0.8 (methylene and methine of the PIB chain)

### Block Copolymer 2:

Preparation of a block copolymer of ABA structure from PIBSA 1000 and polyethylene glycol 6000

Reaction of PIBSA₁₀₀₀ (hydrolysis number HN=86 mg/g KOH) with Pluriol® E6000 (polyethylene oxide, Mₙ≈6000)

In a 4 l three-neck flask with internal thermometer, reflux condenser and nitrogen tap, 783 g of PIBSA (Mₙ=1305; DP=1.5) and 1800 g of Pluriol® E6000 (Mₙ≈6000, DP=1.1) were introduced. In the course of heating to 80° C., the flask was evacuated 3× and blanketed with N₂. The mixture was heated to 130° C. and held at this temperature for 3 h. Thereafter the product was cooled to room temperature and investigated spectroscopically:

IR spectrum (KBr) in cm⁻¹:

OH stretching vibration at 3310; C—H stretching vibration at 2956, 2890, 2745; C═O stretching vibration at 1732; C═C stretching vibration at 1640; further vibrations of the PIB skeleton: 1471, 1388, 1365, 1232; ether vibration of the Pluriol at 1109.

1-H-NMR spectrum (CDCl₃, 500 MHz, TMS, room temperature) in ppm: comparable with example 1, different intensities: 4.9-4.7 (C═C of PIBSA); 4.3-4.1 (C(O)—O—CH₂—CH₂—); 3.8-3.5 (O—CH₂—CH₂—O, PEO chain); 3.4 (O—CH₃); 3.1-2.9; 2.8-2.4; 2.3-2.1; 2.1-0.8 (methylene and methine of the PIB chain)

### Comparative Polymer

Polyisobutene comprising terminal, polar group (as per WO 04/35635)

Reaction of PIBSA₁₀₀₀ (hydrolysis number HN=86 mg/gKOH) with tetraethylenepentamine

A 2 l four-neck flask is charged with 582 g of PIBSA (85% α-olefin content, Mₙ=1000; DP=1.70; based on polyisobutene) and 63.8 g of ethylhexanol under inert gas atmosphere (N₂ protection). After heating to 140° C. 99.4 g of tetraethylpentamine are added dropwise. On completion of the addition the mixture is heated to 160° C. and held at 160° C. for 3 h. During the reaction, some volatiles pass over. To complete the reaction, the pressure is reduced to 500 mbar for 30 min toward the end of the reaction. This is followed by cooling down to room temperature.

IR spectrum: NH vibration at 3295, 1652 cm⁻⁴, C═O stretching vibration of succinimide skeleton at 1769, 1698 cm⁻¹. Other vibrations of PIB skeleton: 2953, 1465, 1396, 1365 and 1238 cm⁻¹.

### B) Dyeing Tests

Production of inventive undyed polymeric compositions:

The following polymers were used for the tests:

polypropylene: Moplen HP 561 S (from Basell). Moplen HP 561 S is a homopolypropylene (metallocene catalysis) having a very narrow molecular weight distribution. It is specifically suitable for spinning continuous filaments and nonwovens. Product data of HP 561 S homopolypropylene without further additions:

| Properties | Method | Unit | Values |
|---|---|---|---|
| Melt flow rate | ISO 1133 | g/10 min | 33 |
| Tensile strength | ISO 527-1, -2 | MPa | 35 |
| Elongation | ISO 527-1, -2 | % | 9 |
| Elongation at break | ISO 527-1, -2 | % | >50 |
| Softening point | ISO 306 | ° C. | 152 |
| Temperature of | ISO 75B-1, -2 | ° C. | 86 |
| deflection under load | | | |
| Density | ISO 1183 | g/cm³ | 0.89-0.91 |

In each of two different tests 5% by weight of the abovementioned block copolymers 1 and 2 was added to the polypropylene chips. A sample with the comparative polymer was also produced, for comparison.

The tests were carried out in a twin-screw extruder at a housing temperature of 180° C. and 200 rpm. Die outputs are 1×4 mm.

The throughput is 5 kg/h, and the block copolymer and the comparative polymer are each melted at 80° C. and added at a throughput of 250 g/h. The metering pump runs at 100-200 g/h.

### Spinning:

The stretch ratio is 3:1 and the linear density is 17 dtex. Spinning takes place at a temperature between 200° C. and 230° C.

### Production of Textile Sheet Materials:

All the extruded and additized polymeric fibers were processed into woven or loop-drawingly knit fabrics which were dyed by the hereinbelow specified methods. The use of textile sheet materials ensures the evaluation of the levelness of textile-finishing operations and, for example, of the hand.

The textile sheet materials obtained were used for dyeing tests:

Dyeings with Disperse Dyes:

The dyeings were carried out by heating the knits produced as described above in demineralized water in the presence of the stated dyes in the stated amounts at pH 4.5 in an AHIBA dyeing machine from initially 90° C. to 130° C. over 40 minutes at a heating rate of 1° C./min and leaving them at 130° C. for a further 60 minutes. The liquor ratio, i.e., the ratio of the volume of the treatment bath in liters to the mass of the dry polypropylene knit in kilograms, was 50:1. After dyeing, the dyeings were cooled down to about 90° C., removed, rinsed cold and dried at 100° C.

Liquor ratio=50:1 (Note. The long liquor ratios reported here were employed on account of the small quantities of substrate and do not reflect upon the substances used according to the present invention. On an industrial, i.e., manufacturing, scale, the very short liquor ratios hitherto customary can be employed).

### Disperse Dyes Used:

Disperse Yellow 114, Disperse Red 60, Disperse Red 82 and Disperse Blue 56 were used in separate tests. An amount of 2% by weight based on the mass of the textile to be dyed was used.

Dyeings with Acid Dyes:

The dyeings were carried out in the same way as the disperse dyeings, except that the dyebath was held to a maximum temperature of 105° C.

### Acid Dyes Used:

Commercially available yellow, red and blue acid dyes were used in an amount of 2% by weight based on the mass of the textile to be dyed.

Evaluation of textiles obtained:

The appraisal was done with reference to the following parameters:
Depth of shade achieved
Levelness; particular attention here was paid to the question of whether there was stripiness to be observed or not. Stripiness describes the phenomenon where individual fibers or fiber bundles of textile were dyed to different intensities, creating a stripy pattern.
Wash fastness; to determine the wash fastness of the dyeings obtained, they were each subjected to a rapid wash with 2 g/l of a laundry detergent for delicates, at a liquor ratio of 200:1, at 60° C. for 5 minutes. The judging criterion was whether the PP dyeing became lighter during the wash, i.e., whether dye bled off, and whether undyed adjacent fabric became tainted or stained.
Rub fastness; dyes that are only superficially lodged on the fiber are easily rubbed off, whereas dyes that are distributed in the fiber cannot be rubbed off.

The textiles dyed with the block copolymers 1 and 2 used according to the present invention as auxiliaries exhibited a deep shade for both disperse dyeing and acid dyeing. The dyed knits did not have a harsh hand.

The textiles were free of stripiness (see illustration 1).

All the substances according to the present invention gave very good wash fastnesses.

The rub fastness of the textiles was good. A micrograph shows that the dye has become homogeneously distributed in the fiber (see illustration (3)).

A knit composed of non-additized polypropylene was dyed under the same conditions for comparison. But it merely became lightly tainted or stained by the dyes.

Further for comparison, polypropylene was additized with the above-mentioned comparative polymer (PIB with terminal, more polar end group from tetraethylenepentamine) in the same manner. Dyeing tests were carried out with commercially available blue and red vat dyes. The textile exhibited a less deep shade than resulted from the use of the block copolymers used according to the present invention, but in particular a very pronounced stripiness (illustration 2). The rub fastness was only low. An electron micrograph showed that the fibers were only superficially dyed (see illustration 4).

### Schedule of Illustrations

Illustration 1 shows a textile dyed according to the present invention with a blue disperse dye.

Illustration 2 shows a textile additized with the comparative polymer and dyed with a vat dye.

Illustration 3 shows a section through polypropylene fibers dyed according to the present invention with a red dye.

Illustration 4 shows a section through polypropylene fibers additized with the comparative polymer and dyed with a red vat dye.

### C) Printing Tests

Printing pastes used according to the present invention were prepared in accordance with the following prescription:

### Method of Making Stock Thickening:

72 g of galactomannan thickening (Diagum A12, from Diamalt) are dissolved in 800 ml of water by intensive stirring, 12 g of sodium p-nitrobenzenesulfonate and 12 g of an oleic acid ethoxylated with 25 mol of EO are stirred into the resulting paste until the paste is homogeneous. Then, 4 g of oxo oil 13 and 1.2 g of aqueous citric acid are stirred in. Then, the paste is made up to 1000 ml and the stock paste obtained is homogenized by intensive stirring.

### Method of Making the Printing Paste:

X g of dye dispersion are homogenized with 100-x g of the stock thickening by intensive stirring. Identity and type of dyes used are reported hereinbelow.

### Description of Printing Operation

The loop-formingly knit fabric is fixed on the printing table by means of commercially available printing table adhesives. An E 55 gauze screen-printing screen having a striped pattern 4 cm in width is then placed on the fabric. The printing paste is applied to the edge of the screen. A round squeegee 15 mm in diameter is then placed at the edge of the screen and magnetically pulled at strength setting 6 over the area to be printed.

This is followed by drying at 80° C. in a drying cabinet and a subsequent 10 min fixation in superheated steam at 130° C. or 140° C.

All the prints were subjected to the following aftertreatment:
cold rinse in overflow
hot rinse in overflow
reduction clear with
   2 g/l of hydrosulfite
   3 ml/l of 50% caustic
   1 g/l of sodium nitrilotriacetate
   2 g/l of C₁₋₃ alcohol ethoxylated with 5 mol of EO
   treatment time 10 min, 80° C., liquor ratio 15:1
warm rinse in overflow
cold rinse in overflow
min drying at 80° C. in drying cabinet

### Textile Substrates Used:

The printing tests utilized loop-formingly knit polypropylene fabrics of additized polypropylene fibers. Production was described above.

The following additives are used in each case:

Fabric 1: no additive (for purposes of comparison)

Fabric 2: 3.5% by weight of block copolymer 2 (1000-6000-1000)

Fabric 3: 5% by weight of block copolymer 1 (550-1500-550)

Fabric 4: mixture of 1% by weight of block copolymer 2 (1000-6000-1000) with 3% of PET

The following dyes were used:

| | |
|---|---|
| C.I. Disperse Yellow 54 | (Dianix Gelb S-3G, from Dystar) |
| C.I. Disperse Red 91 | (Dianix Rot S-BEL, from Dystar) |
| C.I. Disperse Blue 60 | (Dianix Türkis S-3G, from Dystar) |
| Commercially available black dye | (Dianix Schwarz S-2B, from Dystar) |

The quality of the prints was tested with regard to their rub fastness and wash fastness at 60° C.

Wash fastness was tested on the lines of DIN ISO en 105 C 03. The fabric was washed under standardized conditions after dyeing or printing. Adjacent strips of other materials were washed together with the knit fabric. These strips should remain white; that is, dye should not transfer to them from the other textiles in the wash. Scores of 1 to 5 are awarded, 5 denoting pure white, 1, badly stained.

Rub fastness was tested in accordance with DIN ISO en 105×12. The results were scored on a scale from 1 to 5, 5 being the best and 1 the worst rating.

The experimental conditions and the results obtained are presented in tables 1 to 3. table 4 shows the results of a comparative printing on a polyester knit.

The non-additized knit 1 used for comparison merely became lightly tainted, not dyed.

TABLE 1
Experimental parameters and results on knit 2

| | 1 | 2 | 3 | 4 | 5 | 6 | 7 | 8 |
|---|---|---|---|---|---|---|---|---|
| Stock thickening | 99.6 | 97.65 | 98 | 96.1 | 99.6 | 97.65 | 98 | 96.1 |
| Disperse Yellow 54 | 0.4 | | | | 0.4 | | | |
| Disperse Red 91 | | 2.35 | | | | 2.35 | | |
| Disperse Blue 60 | | | 2.0 | | | | 2.0 | |
| Dianix Black S-2B | | | | 3.9 | | | | 3.9 |
| Fixing temperature | 130 | 130 | 130 | 130 | 140 | 140 | 140 | 140 |
| Rub fastness dry | 5 | 5 | 5 | 5 | 5 | 5 | 5 | 5 |
| Rub fastness wet | 5 | 5 | 5 | 5 | 5 | 5 | 5 | 5 |
| Wash fastness 60° | | | | | | | | |
| Adjacent wool | 4-5 | 4-5 | 4-5 | 4 | 4-5 | 4-5 | 4 | 4 |
| Adjacent acrylic | 5 | 5 | 5 | 4-5 | 5 | 4-5 | 5 | 5 |
| Adjacent polyester | 5 | 4-5 | 5 | 4 | 5 | 5 | 5 | 4 |
| Adjacent polyamide | 4-5 | 3 | 5 | 3 | 4-5 | 3 | 5 | 3-4 |
| Adjacent cotton | 5 | 4-5 | 5 | 4-5 | 5 | 5 | 5 | 4-5 |
| Adjacent diacetate | 4-5 | 3-4 | 5 | 3-4 | 4-5 | 3-4 | 5 | 3-4 |

TABLE 2
Experimental parameters and results on knit 3

| | 9 | 10 | 11 | 12 | 13 | 14 | 15 | 16 |
|---|---|---|---|---|---|---|---|---|
| Stock thickening | 99.6 | 97.65 | 98 | 96.1 | 99.6 | 97.65 | 98 | 96.1 |
| Disperse Yellow 54 | 0.4 | | | | 0.4 | | | |
| Disperse Red 91 | | 2.35 | | | | 2.35 | | |
| Disperse Blue 60 | | | 2.0 | | | | 2.0 | |
| Dianix Black S-2B | | | | 3.9 | | | | 3.9 |
| Fixing temperature | 130 | 130 | 130 | 130 | 140 | 140 | 140 | 140 |
| Rub fastness dry | 5 | 5 | 5 | 5 | 5 | 5 | 5 | 5 |
| Rub fastness wet | 5 | 5 | 5 | 5 | 5 | 5 | 5 | 5 |
| Wash fastness 60° | | | | | | | | |
| Adjacent wool | 4-5 | 4-5 | 4-5 | 4 | 4 | 4 | 4 | 3 |
| Adjacent acrylic | 5 | 5 | 5 | 4-5 | 5 | 5 | 5 | 5 |
| Adjacent polyester | 5 | 5 | 5 | 4-5 | 5 | 5 | 5 | 4-5 |
| Adjacent polyamide | 4-5 | 5 | 5 | 4-5 | 4-5 | 3-4 | 5 | 4 |
| Adjacent cotton | 5 | 4 | 5 | 5 | 5 | 5 | 5 | 5 |
| Adjacent diacetate | 5 | 4-5 | 5 | 4-5 | 5 | 4 | 5 | 4-5 |

TABLE 3
Experimental parameters and results on knit 4

| | 17 | 18 | 19 | 20 | 21 | 22 | 23 | 24 |
|---|---|---|---|---|---|---|---|---|
| Stock thickening | 99.6 | 97.65 | 98 | 96.1 | 99.6 | 97.65 | 98 | 96.1 |
| Disperse Yellow 54 | 0.4 | | | | 0.4 | | | |
| Disperse Red 91 | | 2.35 | | | | 2.35 | | |
| Disperse Blue 60 | | | 2.0 | | | | 2.0 | |
| Dianix Black S-2B | | | | 3.9 | | | | 3.9 |
| Fixing temperature | 130 | 130 | 130 | 130 | 140 | 140 | 140 | 140 |
| Rub fastness dry | 5 | 5 | 5 | 5 | 5 | 5 | 5 | 5 |
| Rub fastness wet | 5 | 5 | 5 | 5 | 5 | 5 | 5 | 5 |
| Wash fastness 60° | | | | | | | | |
| Adjacent wool | 4-5 | 4 | 4 | 3-4 | 4-5 | 4 | 4-5 | 3-4 |
| Adjacent acrylic | 5 | 5 | 5 | 4-5 | 5 | 5 | 5 | 4-5 |
| Adjacent polyester | 5 | 4-5 | 5 | 3-4 | 5 | 5 | 5 | 3-4 |
| Adjacent polyamide | 4-5 | 2 | 5 | 2-3 | 4-5 | 2-3 | 5 | 2-3 |
| Adjacent cotton | 5 | 4-5 | 5 | 4-5 | 5 | 4-5 | 5 | 4-5 |
| Adjacent diacetate | 5 | 3 | 5 | 3 | 4-5 | 3 | 5 | 3 |

TABLE 4
Experimental parameters and results of printing on PET knit

| | 25 | 26 | 27 | 28 | 29 | 30 | 31 | 32 | 33 | 34 | 35 | 36 |
|---|---|---|---|---|---|---|---|---|---|---|---|---|
| Stock thickening | 99.6 | 97.65 | 98 | 96.1 | 99.6 | 97.65 | 98 | 96.1 | 99.6 | 97.65 | 98 | 96.1 |
| Disperse Yellow 54 | 0.4 | | | | 0.4 | 0.4 | | | | | | |
| Disperse Red 91 | | 2.35 | | | | 2.35 | | 2.35 | | | | |
| Disperse Blue 60 | | | 2.0 | | | | 2.0 | | | 2.0 | | |
| Dianix BlackS-2B | | | | 3.9 | | | | 3.9 | | | | 3.9 |
| Fixing temperature | 130 | 130 | 130 | 130 | 140 | 140 | 140 | 140 | 175 | 175 | 175 | 175 |
| Rub fastness dry | 5 | 5 | 5 | 5 | 5 | 5 | 5 | 5 | 5 | 5 | 5 | 5 |
| Rub fastness wet | 5 | 5 | 5 | 5 | 5 | 5 | 5 | 5 | 5 | 5 | 5 | 5 |
| Wash fastness 60° | | | | | | | | | | | | |
| Adjacent wool | 5 | 5 | 5 | 4-5 | 5 | 5 | 4-5 | 4-5 | 5 | 5 | 5 | 5 |
| Adjacent acrylic | 5 | 5 | 5 | 4-5 | 5 | 5 | 4-5 | 4-5 | 5 | 5 | 5 | 5 |
| Adjacent polyester | 5 | 5 | 5 | 3 | 5 | 5 | 5 | 3-4 | 5 | 5 | 5 | 5 |
| Adjacent polyamide | 4-5 | 4-5 | 5 | 3-4 | 4-5 | 5 | 5 | 4 | 5 | 5 | 5 | 5 |
| Adjacent cotton | 5 | 5 | 5 | 4 | 5 | 5 | 5 | 4-5 | 5 | 5 | 5 | 5 |
| Adjacent diacetate | 4-5 | 5 | 5 | 4 | 5 | 4 | 5 | 4 | 5 | 5 | 5 | 5 |

The printing tests show that very wash- and rub-fast prints are obtained on printing formed-loop knits composed of the polymeric composition of the present invention. In addition, the hues obtained are very bright and of substantial depth of shade.

### D) Production of Filled Polypropylene

Samples of polypropylene were each processed as described above in a melt extruder with a commercially available CaCO₃ filler 2 μm in particle size to form a filled polypropylene. The samples each comprised 20% by weight of CaCO₃, based on all the components of the composition.

The inventive example additionally incorporated 0.8% by weight or 3% by weight of block copolymer 2, both based on the amount of CaCO₃.

For comparison, the pure, uncoated CaCO₃ was coated once with PIBSA₁₀₀₀ and, in a further test, with stearic acid, which is customarily used as an auxiliary for incorporating CaCO₃ fillers. Of the fillers thus coated, 20% by weight of each was incorporated in the polypropylene. Each sample was subjected to determinations of the melt flow index (according to ISO 1133), impact toughness (according to ISO 180/1A) and also breaking extension (according to ISO 527-2). The results are summarized in table 5.

TABLE 5
Properties of various filled polypropylene samples

| No. | Example C1 | Example C2 | Comparison 1 | Comparison 2 | Comparison 3 |
|---|---|---|---|---|---|
| Filler | 20% of CaCO₃ | 20% of CaCO₃ | — | 20% of CaCO₃ | 20% of CaCO₃ |
| Addition, identity | Block | Block | — | Stearic acid | PIBSA₁₀₀₀ |
| | copolymer 2 | copolymer 2 | | | |
| Amount | 0.8% | 3.0% | — | 0.8% | 0.8% |
| MFR | 22 | 18.2 | 35 | 31 | 30 |
| (230° C./2.16 kg) | | | | | |
| [cm³/10 min] | | | | | |
| Impact toughness | 3.5 | 4.0 | 2.2 | 3.4 | 3.5 |
| [kJ/m²] | | | | | |
| Breaking | 203 | 64 | 528 | 39 | 34 |
| extension [%] | | | | | |

### Commentary:

When polypropylene is filled with CaCO₃ using the conventional auxiliary stearic acid, the breaking extension of the filled polypropylene obtained is reduced dramatically to just 39%. Using, instead, in accordance with the present invention, amphiphilic block copolymers, the breaking extension achieved ranged from 64% to 203%, depending on the amount of block copolymer used, and is accordingly about 2 to 5 times greater than when stearic acid is used, and all that without a reduction in the impact toughness of the product. PIBSA alone does not have this effect.

### E) Texturing of Solution-Dyed Polypropylene Fibers

### Preliminary Remark:

Texturing transforms flat manufactured continuous filament fibers through a heat treatment into bulkier, more or less elastic yarns, but the extensibility of the yarns shall ideally not be reduced by the texturing operation.

### Experimental Procedure:

The texturing experiments were carried out using an AFK-2 false twist texturing machine from Barmag of Remscheid. Tests were carried out at various texturing speeds ranging from 400 m/s to 1000 m/s. The temperature of the heater was raised linearly from 200-220° C. at 400 m/s to 250-270° C. at 1000 m/s.

Polypropylene without additive and polypropylene with 5% by weight of block copolymer 2 were used. The compositions were produced as described above by melt extrusion at 2500 ml/min and spun to form a POY fiber which was used for the texturing experiments. The target fiber linear density for the DTY was 82.7 dtex for 34 filaments.

Elongation tests were carried out on the yarn obtained. The results are shown in table 6. The additized yarn exhibits elongation at high texturing speeds in particular superior to that of the nonadditized polypropylene, leading to superior process stability.

TABLE 6
Elongation of texturized yarn as a function of texturing speed with and without
5% of block copolymer 2.

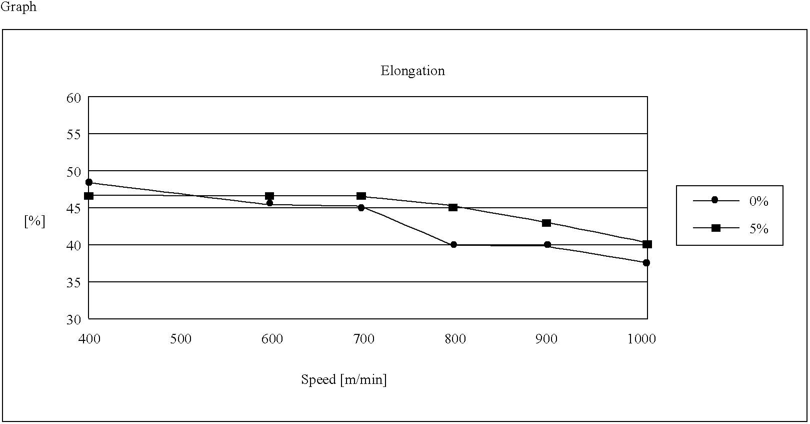

It is generally remarkable that texturing speeds of more than 400 m/min could be achieved. Compared to solution-dyed polypropylene, yarn tensile strength is so low from a pigmentation level of about 3% that the yarn breaks at high speeds. Consequently, doubling the texturing speed would significantly reduce these processing posts.

F) Compositions with Additional Polymers

Production of a polyester having a melting point of 94° C.

A first reaction stage was carried out in a nitrogen atmosphere at 230 to 240° C. to react 14 kg of adipic acid, 9.344 kg of 1,4-butanediol and 0.1 g of tin dioctoate. The bulk of the water formed was distilled off and then 0.02 g of tetrabutyl orthotitanate was added. The reaction was continued until the acid number had dropped to below 1. Thereafter, excess butanediol was distilled off under reduced pressure to an OH number of 56.

In a second reaction stage 720.8 g of the polyester obtained from adipic acid and butanediol were heated with 454.4 g of dimethyl terephthalate, 680 g of 1,4-butanediol and also 2 g of tetrabutyl orthotitanate to 180° C. under nitrogen with slow stirring. Methanol formed was distilled off. Thereafter, the temperature was raised to 230° C. in the course of 2 h at which point 13.08 g of pyromellitic dianhydride were added, followed by 0.8 g of an aqueous solution of phosphorous acid (50% by weight) after a further hour. Excess butanediol was then distilled off at reduced pressure.

The polyester obtained had a melting point of 94° C., an OH number of 16 mg of KOH/g and an acid number of less than 1 mg of KOH/g.

A composition of 95% by weight of polypropylene, 3.75% by weight of the polyester described and also 1.25% by weight of block copolymer 2 was produced as above by melt extrusion, spun into fiber at 230° C., and textiles were produced from the fibers as described above. In the process, DTY linear densities between 35 dtex 32 filaments and 260 dtex/12 filaments were spun. The additive was added at a rate of 10% from concentrate.

Dyeing tests were carried out on the textiles. The dyeing tests were carried out as described above.

The addition of small amounts of polyesters having a low melting point yielded a number of additional benefits compared to inventive compositions without the addition:
Dyeing temperatures of 100° C. are sufficient. This is important for carpet dyeing.
Liquor exhaustion is better; i.e., the fiber takes up more dye. Accordingly, the dyeing process is less costly and there is less dye left in the wastewater.
Finer linear densities can be spun, for example microfibers of 1 dtex/filament.

1-24. (canceled)

25. A polymeric composition comprising at least one polyolefin and at least one block copolymer comprising, wherein said block copolymer comprises
(a) at least one hydrophobic block (A) comprising essentially isobutene units, wherein the average molar mass Mₙ of said at least one hydrophobic block (A) is in the range of from 200 to 10,000 g/mol; and
(b) at least one hydrophilic block (B) comprising essentially oxyalkylene units, wherein the average molar mass Mₙ of said at least one hydrophilic block (B) is in the range of from 1000 to 20,000 g/mol;
wherein said polymeric composition is present as a molding or as a film, said at least one polyolefin comprises a homo- or copolymer of polypropylene or of polyethylene, and said polymeric composition further comprises polyester or polyamides.

26. The polymeric composition of claim 25, wherein said polymeric composition is in the form of fibers, yarns, wovens, nonwovens, knits, and/or other textile materials.

27. The polymeric composition of claim 26, wherein said fibers, yarns, wovens, nonwovens, knits, and/or other textile materials are in the form of apparel or home textiles.

28. The polymeric composition of claim 26, wherein said apparel textiles are selected from the group consisting of sportswear, underwear, outerwear, jackets, and functional underwear.

29. The polymeric composition of claim 26, wherein said home textiles are selected from the group consisting of curtains, table cloths, bedding, upholstery fabrics, and carpets.

30. The polymeric composition of claim 25, wherein said at least one polyolefin comprises a homo- or copolymer of polypropylene.

31. The polymeric composition of claim 30, wherein said homo- or copolymer of polypropylene has an MFR melt flow index (230° C., 2.16 kg) of less than 40 g/10 min.

32. The polymeric composition of claim 25, wherein said polymeric composition comprises polyester having a melting point in the range of from 50 to 250° C.

33. The polymeric composition of claim 25, wherein said hydrophilic block (B) comprises at least 50% by weight of ethylene oxide units.

34. The polymeric composition of claim 25, wherein said block copolymer is at least one triblock copolymer of general formula A-B-A.

35. The polymeric composition of claim 25, wherein said block copolymer is a mixture of at least one triblock copolymer of general formula A-B-A and at least one diblock copolymer of general formula A-B

36. The polymeric composition of claim 25, wherein said at least one polyolefin is present in an amount of from 35% to 99.95% by weight and said block copolymer is present in an amount of from 0.05% to 10% by weight, based in each case on the total weight of all components of said polymeric composition.

37. The polymeric composition of claim 25, wherein said polymeric composition further comprises at least one filler.

38. The polymeric composition of claim 37, wherein said filler is selected from the group consisting of CaCO₃, Al(OH)₃, Mg(OH)₂, talc, glass fibers, sheet-silicates, and combinations thereof.

39. The polymeric composition of claim 38, wherein said filler comprises a nanoparticulate sheet-silicate.

40. The polymeric composition of claim 39, wherein said filler further comprises a flame retardant.

41. The polymeric composition of claim 25, further comprising at least one dye.

42. The polymeric composition of claim 41, wherein said dye is a disperse dye.

43. A process for producing the polymeric composition of claim 25, comprising (1) heating said polyolefins, block copolymers, and also further components to form a molten fluid, (2) intensively mixing said polyolefins, block copolymers, and also further components with each other by means of suitable apparatus, (3) discharging the molten polymeric composition from the mixing assembly via dies, (4) and forming said molten polymeric composition into the desired moldings.

44. The process of claim 43, wherein said molten polymeric is formed into fibers.

45. The process of claim 44, wherein said fibers are further processed into yarns, wovens, nonwovens, or other textile materials.

46. The process of claim 45, wherein said yarns, wovens, nonwovens, or other textile materials are further processed into apparel or home textiles.

47. The process of claim 46, wherein said apparel textiles are selected from the group consisting of sportswear, underwear, outerwear, jackets, and functional underwear.

48. The process of claim 47, wherein said home textiles are selected from the group consisting of curtains, table cloths, bedding, upholstery fabrics, and carpets.
